(19) United States
(12) Patent Application Publication
(10) Pub. No.: US 2012/0224080 A1
(43) Pub. Date: Sep. 6, 2012

(54) IMAGE PICKUP LENS, IMAGE PICKUP DEVICE USING SAME, AND PORTABLE DEVICE EQUIPPED WITH THE IMAGE PICKUP DEVICE

(75) Inventors: Takumi Iba, Kyoto (JP); Masatoshi Yamashita, Osaka (JP)

(73) Assignee: PANASONIC CORPORATION, Kadoma-shi, Osaka (JP)

(21) Appl. No.: 13/510,225

(22) PCT Filed: Aug. 18, 2010
(86) PCT No.: PCT/JP2010/005102

§ 371 Date: May 16, 2012

(30) Foreign Application Priority Data
Nov. 24, 2009 (JP) 2009-266614

(51) Int. Cl. H04N 5/225

(52) U.S. Cl. 348/222.1; 348/E05.024

(57) ABSTRACT

The present invention provides an image pickup lens capable of adequately suppressing flare caused by unnecessary diffraction order light. An image pickup lens 7 includes, in order from an object side to an image surface side: an aperture stop 5, a first lens 1 having positive power; a second lens 2 that is a meniscus lens having negative power and whose lens surface facing the image surface side is concave; a third lens 3 that is a meniscus lens having positive power and whose lens surface facing the image surface side is convex; and a fourth lens 4 that has negative power, whose lens surfaces are both aspherical and whose lens surface facing the image surface side is concave near the optical axis. A diffractive optical element is formed on the lens surface of the first lens 1 facing the image surface side. The lens surface provided with the diffractive optical element has 3 or fewer diffraction zones within its effective diameter, and the image pickup lens satisfies the following conditional expression (1):

f_{DOE}/f>30 (1)

where f is a focal distance of an overall optical system, and f_{DOE} is a focal distance of the diffractive optical element alone.

### TECHNICAL FIELD

The present invention relates to an image pickup lens suitable for small portable devices, such as mobile phones, digital cameras and small cameras, equipped with an image pickup device. The present invention also relates to an image pickup device using the image pickup lens and to a portable device equipped with the image pickup device.

### BACKGROUND ART

Small portable devices, such as mobile phones, equipped with an image pickup device (camera module) have become widely popular in recent years, and taking pictures instantly with such small portable devices has become a common practice. For small image pickup devices incorporated in such small portable devices, an image pickup lens composed of three lenses is proposed (see Patent Document 1, for example). This image pickup lens has a small overall length and excellent optical performance.

The image pickup lens described in Patent Document 1 includes, in order from the object side to the image surface side: a first lens having positive refractive power; a second lens having positive or negative refractive power; and a third lens for correcting aberrations. A diffractive optical element is formed on at least one lens surface of the first lens or the second lens, and the lens surface provided with the diffractive optical element is formed so as to have 20 or fewer diffraction zones within the area through which effective light beams pass.

### PRIOR ART DOCUMENT

### Patent Document

Patent Document 1: JP 2007-86485 A

### SUMMARY OF INVENTION

### Problem to be Solved by the Invention

Attempts have been made in recent years to enhance the image quality of image pickup devices by using, for example, small high-pixel image pickup elements such as CCD and CMOS image sensors having a pixel pitch of 2 μm or less and a pixel count of 5 mega pixels, 8 mega pixels or 13 mega pixels.

However, for an image pickup device using the image pickup lens described in Patent Document 1, flare caused by unnecessary diffraction order light cannot be adequately suppressed because the image pickup lens has 20 or fewer diffraction zones. Thus, even if the image pickup device uses a high-definition image pickup element with a large pixel count, it may be considered that image degradation occurred.

With the foregoing in mind, it is an object of the present invention to provide an image pickup lens capable of adequately suppressing flare caused by unnecessary diffraction order light, a high definition and high image quality image pickup device using the image pickup lens, and a high-performance portable device, such as a mobile phone, equipped with the image pickup device.

### Means for Solving Problem

In order to achieve the above object, the image pickup lens according to the present invention includes at least one lens. A diffractive optical element is formed on at least one lens surface of the at least one lens, and the lens surface provided with the diffractive optical element has 3 or fewer diffraction zones within its effective diameter. When f is a focal distance of an overall optical system, and f_{DOE} is a focal distance of the diffractive optical element alone, the image pickup lens satisfies the following conditional expression (1).

f_{DOE}/f>30 (1)

The diffractive optical element (diffraction grating) produces a high diffraction effect on a design diffraction order light beam, and the order light beam is used to correct chromatic aberration. Hence, light beams other than the design diffraction order light beam are unnecessary diffraction order light, and they form an image around the design diffraction order light and serve as flare components. More specifically, in a diffractive optical element (diffraction grating) having zones in the direction of revolution about the optical axis of an image pickup lens, flare components caused by unnecessary diffraction order light appear on an image surface radially about the optical axis relative to the position of an image formed by a design diffraction order light beam (design diffraction order light).

Hence, according to the configuration of the image pickup lens of the present invention, flare caused by unnecessary diffraction order light can be suppressed adequately. Furthermore, since design diffraction order light can be used to correct chromatic aberration favorably, the image pickup lens of the present invention can be made compatible with small high-pixel image pickup elements. Consequently, by using the image pickup lens of the present invention, it is possible to provide a high definition and high image quality image pickup device.

In the configuration of the image pickup lens of the present invention, the diffractive optical element is preferably of a single layer type. The term “single layer type diffractive optical element” used herein refers to a diffractive optical element formed on one lens surface (lens surface facing the object side or image surface side) of a lens. In contrast, the term “multilayer type diffractive optical element” refers to a plurality of single layer type diffractive optical elements being used in close proximity to each other.

According to this preferred example, it becomes easier to prepare the diffractive optical element than when employing a multilayer type diffractive optical element.

Further, in the configuration of the image pickup lens of the present invention, it is preferable that the image pickup lens further includes an aperture stop, light is incident through the aperture stop, and the diffractive optical element is formed on at least one lens surface of the at least one lens that is disposed closest to the aperture stop. According to this preferred example, light that enters, through the aperture stop, the lens disposed closest to the aperture stop will have a small angle relative to the optical axis, so that chromatic aberration can be corrected favorably. As a result, it is possible to provide an image pickup lens compatible with smaller image pickup elements having a higher pixel count. Thus, by using the image pickup lens of the present invention, a higher resolution and higher image quality image pickup device can be provided.

Further, in the configuration of the image pickup lens of the present invention, it is preferable that the image pickup lens includes at least two lenses and an aperture stop. Of the at least two lenses, a first lens is disposed closest to the object side and a second lens is disposed adjacent to the first lens, the aperture stop is provided on the object side of the first lens, and the diffractive optical element is formed on the lens surface of the second lens facing the object side.

In some cases, it may be difficult to form the diffractive optical element on the first lens disposed closest to the aperture stop, and difficult to achieve an adequate diffraction effect only by forming the diffractive optical element on the first lens. Or, providing the first lens with too much diffraction power would cause a point of inflection in the phase function that defines the shape of the lens surface on which the diffractive optical element is to be formed. As a result, flare may increase in size. In such cases, it is preferable to form the diffractive optical element on the lens surface of the second lens (the lens disposed adjacent to the first lens) facing the object side.

Further, in the configuration of the image pickup lens of the present invention, the image pickup lens preferably has an F number of 2.4 to 3.2. The image pickup lens of the present invention adequately can suppress flare caused by unnecessary diffraction order light regardless of the F number. Thus, according to this preferred example, it is possible to provide a bright image pickup lens having an F number of 2.4 to 3.2 and capable of adequately suppressing flare caused by unnecessary diffraction order light.

Further, the image pickup device of the present invention includes: an image pickup element for converting an optical signal corresponding to an object into an image signal and outputting the image signal; and an image pickup lens for forming an image of the object onto an image pickup surface of the image pickup element. The image pickup lens of the present invention is used as the image pickup lens.

According to the configuration of the image pickup device of the present invention, the image pickup lens of the present invention is used as the image pickup lens. Thus, flare caused by unnecessary diffraction order light can be suppressed adequately. Furthermore, since design diffraction order light can be used to correct chromatic aberration favorably, a small high-pixel image pickup element can be used. As a result, a high definition and high image quality image pickup device can be provided.

The portable device of the present invention is equipped with the image pickup device of the present invention.

According to the configuration of the portable device of the present invention, the portable device is equipped with the image pickup device of the present invention, so that the definition and image quality of the portable device can be enhanced. Thus, it is possible to provide a high-performance portable device such as a mobile phone.

### Effects of the Invention

As described above, according to the present invention, it is possible to provide an image pickup lens capable of adequately suppressing flare caused by unnecessary diffraction order light, a high definition and high image quality image pickup device using the image pickup lens, and a high-performance portable device, such as a mobile phone, equipped with the image pickup device.

### BRIEF DESCRIPTION OF THE DRAWINGS

FIG. 1 is a layout drawing showing a configuration of an image pickup lens according to Embodiment 1 of the present invention.

FIG. 2 shows graphs of aberrations associated with an image pickup lens of Example 1 of the present invention. FIG. 2(a) is a graph of spherical aberration (graph of longitudinal chromatic aberration), FIG. 2(b) is a graph of astigmatism, and FIG. 2(c) is a graph of distortion.

FIG. 3 is a layout drawing showing a configuration of an image pickup lens of Comparative Example of the present invention.

FIG. 4 shows graphs of aberrations associated with the image pickup lens of Comparative Example of the present invention. FIG. 4(a) is a graph of spherical aberration (graph of longitudinal chromatic aberration), FIG. 4(b) is a graph of astigmatism, and FIG. 4(c) is a graph of distortion.

FIG. 5 is a cross-sectional view showing a configuration of an image pickup device according to Embodiment 2 of the present invention.

FIG. 6(a) is a plan view and FIG. 6(b) is a rear view showing a configuration of a mobile phone as a portable device according to Embodiment 3 of the present invention.

### DESCRIPTION OF THE INVENTION

Hereinafter, the present invention will be described in more detail by way of embodiments.

### Embodiment 1

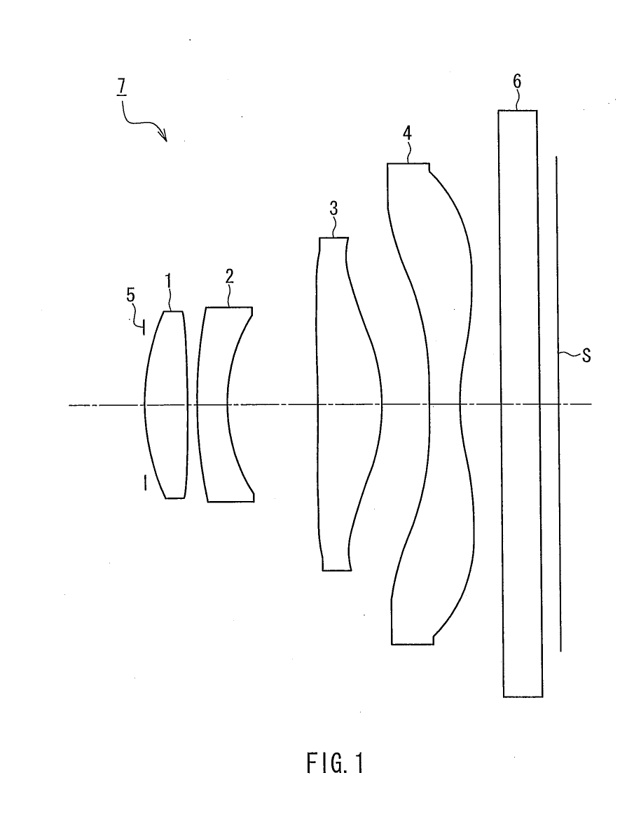

FIG. 1 is a layout drawing showing a configuration of an image pickup lens according to Embodiment 1 of the present invention.

An image pickup lens 7 according to the present embodiment is an image pickup lens including at least one lens. And a diffractive optical element is formed on at least one lens surface of the at least one lens. For example, as shown in FIG. 1, the image pickup lens 7 according to the present embodiment includes, in order from the object side (the left side of FIG. 1) to the image surface side (the right side of FIG. 1): a first lens 1 having positive power; a second lens 2 that is a meniscus lens having negative power and whose lens surface facing the image surface side is concave; a third lens 3 that is a meniscus lens having positive power and whose lens surface facing the image surface side is convex; and a fourth lens 4 that has negative power, whose lens surfaces are both aspherical and whose lens surface facing the image surface side is concave near the optical axis. A diffractive optical element is formed on at least one lens surface of the first lens 1 to the fourth lens 4. Here, the term power refers to an amount defined by the inverse of the focal distance.

The image pickup lens 7 is an imaging single focus lens for forming an optical image (forming an image of an object) onto an image pickup surface S of an image pickup element (e.g., a CCD), and an image pickup element converts an optical signal corresponding to the object into an image signal and outputs the image signal. And as will be described later, the image pickup element and the image pickup lens are used to form an image pickup device, and the image pickup device is used to form a portable device equipped with the image pickup device.

The aspherical shape of each of the lens surfaces can be given by the following formula 1.

$$X = \frac{\frac{{Y}^{2}}{{R}_{0}}}{1 + \sqrt{1 - ( κ + 1 ) {( \frac{Y}{{R}_{0}} )}^{2}}} + A 4 {Y}^{4} + A 6 {Y}^{6} + A 8 {Y}^{8} + A 10 {Y}^{10} + … \qquad [ Formula 1 ]$$

Where Y represents the height from the optical axis, X represents a distance from a tangent plane to the vertex of an aspherical surface of an aspherical shape at height Y from the optical axis, R₀ represents the radius of curvature of the vertex of the aspherical surface, κ represents a conic constant, and A4, A6, A8, and A10 . . . represent 4th-, 6th-, 8th-, and 10th . . . order aspherical coefficients, respectively.

Further, the shape of the lens surface provided with the diffractive optical element (hereinafter referred to as a “diffractive optical element surface”) can be given by the following formula 2.

Φ(ρ)=(2π/λ₀)(C2ρ²+C4ρ⁴) [Formula 2]

Y=ρ

Where Φ(ρ) represents the phase function, Y represents the height from the optical axis, Cn represents n-th order phase coefficient, and λ₀ represents a design wavelength. Note that X is determined by shape converting Φ(ρ) at an M-th diffraction order.

Further, the image pickup lens 7 according to the present embodiment is configured such that the lens surface provided with the diffractive optical element has 3 or fewer diffraction zones within its effective diameter, and the image pickup lens satisfies the following conditional expression (1).

f_{DOE}/f>30 (1)

Where f is the focal distance of the overall optical system, and f_{DOE} is a focal distance of the diffractive optical element alone.

The diffractive optical element (diffraction grating) produces a high diffraction effect on a design diffraction order light beam, and the order light beam is used to correct chromatic aberration. Hence, light beams other than the design diffraction order light beam are unnecessary diffraction order light, and they form an image around the design diffraction order light and serve as flare components. More specifically, in a diffractive optical element (diffraction grating) having zones in the direction of revolution about the optical axis of an image pickup lens, flare components caused by unnecessary diffraction order light appear on an image surface radially about the optical axis relative to the position of an image formed by a design diffraction order light beam (design diffraction order light).

Hence, if the image pickup lens 7 is configured as above, flare caused by unnecessary diffraction order light can be suppressed adequately. Furthermore, since design diffraction order light can be used to correct chromatic aberration favorably, the image pickup lens 7 can be made compatible with small high-pixel image pickup elements. Consequently, by using the image pickup lens 7, it is possible to provide a high definition and high image quality image pickup device.

The present inventors examined how changes in the value of f_{DOE}/f and the number of diffraction zones affected the occurrence of flare in an image pickup lens composed of four lenses. In the image pickup lens, a lens disposed closest to the object side was provided with a diffractive optical element on its lens surface facing the image surface side. The results are provided in Table 1 below.

TABLE 1

| | f_{DOE}/f | | | | | | | |
|---|---|---|---|---|---|---|---|---|
| | 10.9 | 19.4 | 15.5 | 25.0 | 35.0 | 33.2 | 41.2 | 66.1 |
| Number of | 13 | 11 | 6 | 5 | 4 | 3 | 3 | 2 |
| diffraction | | | | | | | | |
| zones | | | | | | | | |
| Flare | Poor | Poor | Poor | Poor | Poor | Good | Good | Good |

In Table 1, “Good” indicates that flare was suppressed adequately and “Poor” indicates that flare could not be suppressed.

As can be seen from Table 1, flare was suppressed adequately when the number of diffraction zones was 3 or fewer and the value of f_{DOE}/f was 30 or more (satisfying the conditional expression (1)).

Further, in the image pickup lens 7 including the first lens 1 to the fourth lens 4 configured as above, a pair of meniscus lenses whose lens surfaces facing each other are concave is used for the second lens 2 and the third lens 3. Thus, the adoption of the image pickup lens 7 allows a reduction in the angle at which a light beam enters the second lens 2 and the third lens 3, so that ray aberration can be reduced. Furthermore, because the lens surfaces of the fourth lens 4 are both aspherical, distortion and field curvature can be corrected favorably. For these reasons, it is possible to provide an image pickup lens compatible with smaller image pickup elements having a higher pixel count.

A transparent parallel plate 6 is disposed between the fourth lens 4 and the image pickup surface S of the image pickup element. Here, the parallel plate 6 is a plate equivalent to an optical low-pass filter, an infrared (IR) cut filter and a faceplate (cover glass) of the image pickup element.

The surfaces from the lens surface of the first lens 1 facing the object side to the surface of the parallel plate 6 facing the image surface side (hereinafter also referred to as “optical surfaces”) will be referred to as, in order from the object side, a “first surface”, a “second surface”, a “third surface”, a “fourth surface” . . . an “eighth surface”, a “ninth surface”, and a “tenth surface”, respectively.

Further, in the configuration of the image pickup lens 7 according to the present embodiment, the diffractive optical element is desirably of a single layer type.

The term “single layer type diffractive optical element” used herein refers to a diffractive optical element formed on one lens surface (lens surface facing the object side or image surface side) of a lens. In contrast, the term “multilayer type diffractive optical element” refers to a plurality of single layer type diffractive optical elements used in close proximity to each other.

In this way, the preparation of the diffractive optical element becomes easy if a single layer type diffractive optical element is employed as the diffractive optical element rather than a multilayer type diffractive optical element.

Further, as shown in FIG. 1, it is desirable that the image pickup lens 7 according to the present embodiment further includes an aperture stop 5, light is incident through the aperture stop 5, and the diffractive optical element is formed on at least one lens surface of the at least one lens that is disposed closest to the aperture stop 5 (the first lens 1 in the above example).

If the image pickup lens 7 is configured in this way, light that enters, through the aperture stop 5, the lens disposed closest to the aperture stop 5 (the first lens 1 in the above example) will have a small angle relative to the optical axis, so that chromatic aberration can be corrected favorably. As a result, it is possible to provide an image pickup lens compatible with smaller image pickup elements having a higher pixel count. Thus, by using the image pickup lens 7 having such a configuration, a higher definition and higher image quality image pickup device can be provided.

Further, in the configuration of the image pickup lens 7 according to the present embodiment, it is desirable that the image pickup lens 7 includes at least two lenses and the aperture stop 5. Of the at least two lenses, the first lens 1 is disposed closest to the object side and the second lens 2 is disposed adjacent to the first lens 1, the aperture stop 5 is provided on the object side of the first lens 1, and the diffractive optical element is formed on the lens surface of the second lens 2 facing the object side.

In some cases, it may be difficult to form the diffractive optical element on the first lens 1 disposed closest to the aperture stop 5, and difficult to achieve an adequate diffraction effect only by forming the diffractive optical element on the first lens 1. Or, providing the first lens 1 with too much diffraction power would cause a point of inflection in the phase function that defines the shape of the lens surface on which the diffractive optical element is to be formed. As a result, flare may increase in size. In such cases, it is desirable to form the diffractive optical element on the lens surface of the second lens 2 (the lens disposed adjacent to the first lens 1) facing the object side. And chromatic aberration can be corrected favorably even when the diffractive optical element is formed on the lens surface of the second lens 2 in this way.

Further, in the configuration of the image pickup lens 7 according to the present embodiment, it is desirable that the image pickup lens has an F number of 2.4 to 3.2. The image pickup lens 7 according to the present embodiment adequately can suppress flare caused by unnecessary diffraction order light regardless of the F number. Thus, by adopting this configuration, it is possible to provide a bright image pickup lens having an F number of 2.4 to 3.2 and capable of adequately suppressing flare caused by unnecessary diffraction order light.

### EXAMPLE

Hereinafter, the image pickup lens according to the present embodiment will be described in more detail by way of a specific example.

Table 2 below provides a specific numerical example of an image pickup lens of the present example.

TABLE 2

| Surface number | r (mm) | d (mm) | n | ν |
|---|---|---|---|---|
| Aperture stop | ∞ | 0.000 | — | — |
| 1st surface | 1.923 | 0.541 | 1.53113 | 55.79 |
| 2nd surface* | −7.769 | 0.100 | — | — |
| 3rd surface | 4.812 | 0.362 | 1.6074 | 27 |
| 4th surface | 1.648 | 1.084 | — | — |
| 5th surface | −28.195 | 0.790 | 1.53113 | 55.79 |
| 6th surface | −1.548 | 0.572 | — | — |
| 7th surface | −6.761 | 0.362 | 1.53113 | 55.79 |
| 8th surface | 1.903 | 0.500 | — | — |
| 9th surface | ∞ | 0.500 | 1.5168 | 64.2 |
| 10th surface | ∞ | 0.184 | — | — |
| Image surface | ∞ | — | — | — |

In Table 2, r (mm) is the radius of curvature of each optical surface, d (mm) is the thickness or distance between each pair of adjacent surfaces of the first lens 1 to the fourth lens 4 and the parallel plate 6 on the optical axis, n is the refractive index of each of the first lens 1 to the fourth lens 4 and the parallel plate 6 at the d line (587.5600 nm), and v is the Abbe's number of each of the first lens 1 to the fourth lens 4 and the parallel plate 6 at the d line (the same applies also to Comparative Example described later). Note that the image pickup lens 7 shown in FIG. 1 is configured based on the data provided in Table 2.

Further, Tables 3A and 3B below provide aspherical coefficients (including conic constants) of the image pickup lens of this example. In Tables 3A and 3B, for example, “E+00” and “E−02” represent “10⁺⁰⁰” and “10⁻⁰²”, respectively (the same applies also to Table 4 and Comparative Example described later).

TABLE 3A

| | κ | A4 | A6 | A8 |
|---|---|---|---|---|
| 1st surface | −8.264885E−01 | 3.478339E−03 | −1.395877E−02 | 1.259880E−02 |
| 2nd surface* | 5.262403E+00 | 1.563984E−02 | −3.949901E−02 | 4.472191E−02 |
| 3rd surface | 0.000000E+00 | −2.554500E−02 | −2.784225E−02 | 6.738735E−02 |
| 4th surface | −2.469064E+00 | 2.387355E−02 | −8.785163E−03 | 2.393477E−02 |
| 5th surface | 2.542179E+02 | 2.036521E−02 | −5.172657E−03 | 7.126806E−04 |
| 6th surface | −4.371303E+00 | −1.389957E−02 | 1.448876E−02 | −3.964906E−03 |
| 7th surface | 0.000000E+00 | −5.354954E−02 | 1.408035E−02 | −2.922938E−04 |
| 8th surface | −1.013898E+01 | −5.250521E−02 | 1.166372E−02 | −1.938024E−03 |

TABLE 3B

| | A10 | A12 | A14 | A16 |
|---|---|---|---|---|
| 1st surface | −1.415569E−02 | 3.382672E−04 | 7.008374E−11 | 0.000000E+00 |
| 2nd surface* | 2.223801E−02 | −4.231476E−02 | −8.231794E−04 | −3.402334E−12 |
| 3rd surface | 5.325527E−02 | −7.661995E−02 | 4.764265E−03 | 1.137858E−11 |
| 4th surface | 3.847257E−02 | −2.265374E−02 | −1.128837E−02 | 1.926412E−04 |
| 5th surface | 1.904400E−04 | −4.801963E−06 | 0.000000E+00 | 0.000000E+00 |
| 6th surface | 1.877576E−03 | −2.999160E−04 | −2.091626E−06 | 0.000000E+00 |
| 7th surface | −1.521441E−04 | 9.448898E−06 | 0.000000E+00 | 0.000000E+00 |
| 8th surface | 1.609900E−04 | −5.567222E−06 | 0.000000E+00 | 0.000000E+00 |

As can be seen from Tables 3A and 3B, in the image pickup lens 7 of this example, the lens surfaces of each of the first lens 1 to the fourth lens 4 are all aspherical. It should be noted, however, that the image pickup lens 7 is not particularly limited to such a configuration. As long as the lens surfaces of the fourth lens 4 are both aspherical, distortion and field curvature can be corrected favorably as mentioned above.

In Tables 2, 3A and 3B, the surface marked with an asterisk (the second surface: the surface of the first lens 1 facing the image surface side) is a diffractive optical element surface and a specific numerical example of the diffractive optical element surface is provided in Table 4 below.

TABLE 4

| | |
|---|---|
| Design wavelength | 546.07 nm |
| Diffraction order | 1 |
| C2 | −1.800000E−03 |
| C4 | −1.550000E−04 |

In this way, in the image pickup lens 7 of this example, the diffractive optical element is formed on the lens surface of the first lens 1 facing the image surface side but the image pickup lens 7 does not have to be configured as such. The same effect can be achieved even if the diffractive optical element is formed on at least one of the lens surface of the first lens 1 to the fourth lens 4.

With regard to the image pickup lens 7 of this example, Table 5 below provides the F number Fno, the focal distance f (mm) of the overall optical system, the overall optical length TL (mm) measured in terms of air, the maximum image height Y′, the value of the conditional expression (1), the effective diameter (radius) (mm) of the diffractive optical element surface, and the number of diffraction zones within the effective diameter.

TABLE 5

| | |
|---|---|
| Fno | 2.88 |
| f (mm) | 4.2 |
| TL (in terms of air) (mm) | 4.99 |
| Y′ | 2.86 |
| Conditional expression (1) f_{DOE}/f | 66.1 |
| Effective diameter of diffractive optical element | 0.91 |
| (radius) (mm) | |
| Number of diffraction zones within effective | 2 |
| diameter | |

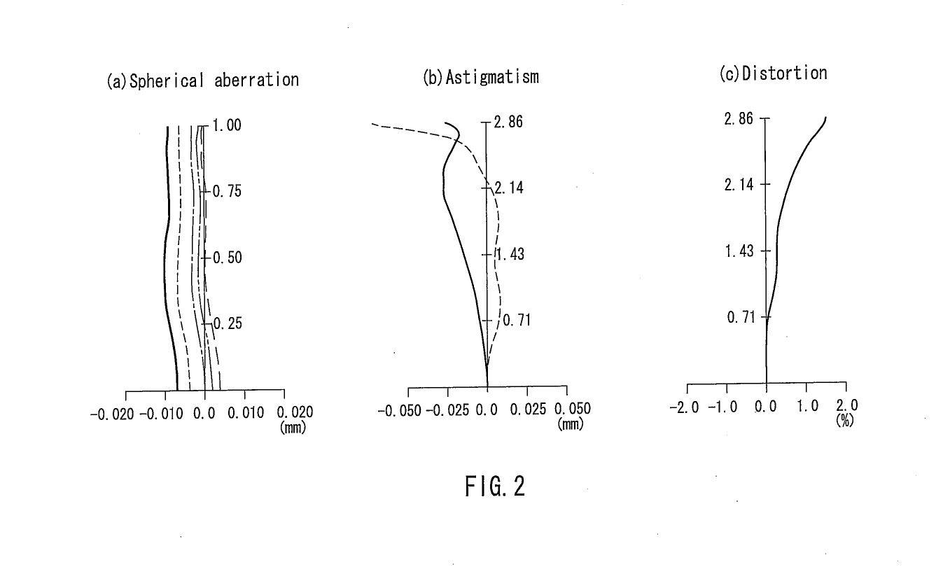

FIG. 2 shows graphs of aberrations associated with the image pickup lens of this example. FIG. 2(a) is a graph of spherical aberration. In FIG. 2(a), a solid line indicates values at the g line (435.8300 nm), a long dashed line indicates values at the C line (656.2700 nm), a short dashed line indicates values at the F line (486.1300 nm), a double chain line indicates values at the d line (587.5600 nm), and a chain line indicates values at the e line (546.0700 nm). FIG. 2(b) is a graph of astigmatism. In FIG. 2(b), a solid line indicates a sagittal field curvature and a dashed line indicates a meridional field curvature. FIG. 2(c) is a graph of distortion. Note that longitudinal chromatic aberration can be read from the graph of spherical aberration in FIG. 2(a).

As can be seen from the graphs of aberration in FIG. 2, the image pickup lens 7 of this example allows favorable correction of a variety of aberrations and is compatible with small high-pixel image pickup elements (e.g., CCD and CMOS image sensors having a pixel pitch of 2 μm or less and a pixel count of 5 mega pixels, 8 mega pixels or 13 mega pixels) incorporated in small portable devices such as mobile phones. Thus, by using the image pickup lens 7 of this example and such a small high-pixel image pickup element, a high definition image pickup device can be provided.

Additionally, in view of the results provided in Tables 1 and 5, it is clear that the image pickup lens 7 of this example adequately can suppress flare caused by unnecessary diffraction order light.

Thus, a high definition and high image quality image pickup device can be provided by using the image pickup lens 7 of this example.

### COMPARATIVE EXAMPLE

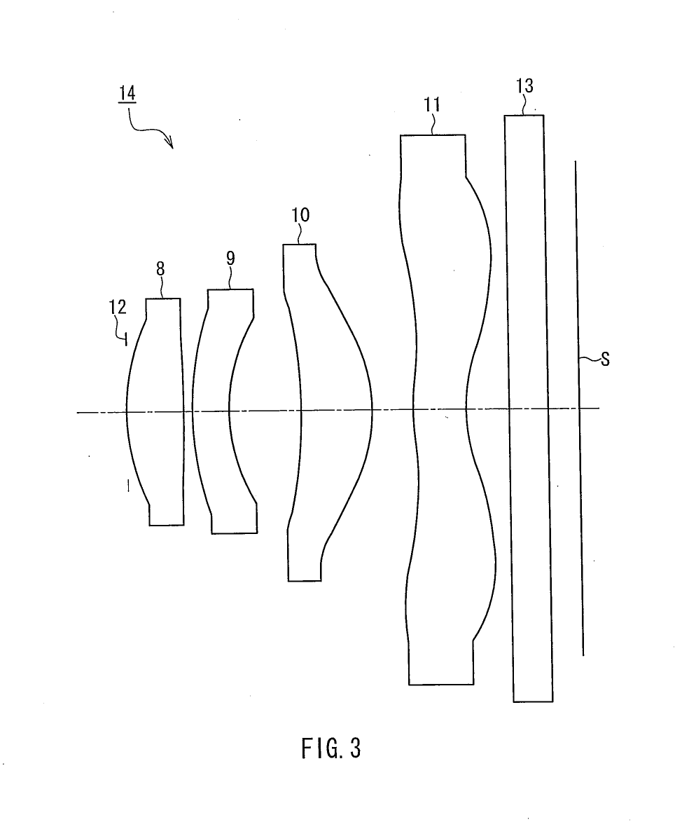

FIG. 3 is a layout drawing showing a configuration of an image pickup lens of a comparative example of the present invention.

As shown in FIG. 3, the image pickup lens 14 of the comparative example includes, in order from the object side (the left side of FIG. 3) to the image surface side (the right side of FIG. 3): an aperture stop 12; a first lens 8 having positive power; a second lens 9 that is a meniscus lens having negative power and whose lens surface facing the image surface side is concave; a third lens 10 that is a meniscus lens having positive power and whose lens surface facing the image surface side is convex; and a fourth lens 11 that has negative power, whose lens surfaces are both aspherical and whose lens surface facing the image surface side is concave near the optical axis.

A transparent parallel plate 13 similar to the parallel plate 6 in Embodiment 1 is disposed between the fourth lens 11 and the image pickup surface S of the image pickup element.

Table 6 below provides a specific numerical example of the image pickup lens of the comparative example. Note that the image pickup lens 14 shown in FIG. 3 is configured based on the data provided in Table 6.

TABLE 6

| Surface number | r (mm) | d (mm) | n | ν |
|---|---|---|---|---|
| Aperture stop | ∞ | 0.000 | — | — |
| 1st surface | 2.242 | 0.634 | 1.53113 | 55.79 |
| 2nd surface | −49.115 | 0.131 | — | — |
| 3rd surface* | 3.578 | 0.440 | 1.6074 | 27 |
| 4th surface | 1.959 | 0.840 | — | — |
| 5th surface | −5.067 | 0.818 | 1.53113 | 55.79 |
| 6th surface | −1.610 | 0.491 | — | — |
| 7th surface | 4.568 | 0.615 | 1.53113 | 55.79 |
| 8th surface | 1.479 | 0.500 | — | — |
| 9th surface | ∞ | 0.500 | 1.5168 | 64.2 |
| 10th surface | ∞ | 0.346 | — | — |
| Image surface | ∞ | — | — | — |

Further, Tables 7A and 7B below provide aspherical coefficients (including conic constants) of the image pickup lens of the comparative example.

TABLE 7A

| | κ | A4 | A6 | A8 |
|---|---|---|---|---|
| 1st surface | −1.292075E−01 | −1.924256E−03 | −6.204868E−04 | 5.129412E−03 |
| 2nd surface | 2.515433E+03 | 1.703634E−02 | −3.716757E−03 | 2.771602E−02 |
| 3rd surface* | −1.763035E+00 | 8.483707E−03 | −1.709138E−02 | 3.681694E−02 |
| 4th surface | −8.051023E−01 | 1.521015E−02 | −1.738961E−02 | 1.006846E−02 |
| 5th surface | −3.737091E+01 | −2.221762E−02 | −2.425486E−03 | 6.349328E−03 |
| 6th surface | −2.862750E+00 | −2.906552E−02 | 1.181844E−02 | −6.731756E−03 |
| 7th surface | −5.391169E+01 | −6.077028E−02 | 1.311410E−02 | −4.371355E−04 |
| 8th surface | −5.397026E+00 | −4.790699E−02 | 1.109192E−02 | −2.125473E−03 |

TABLE 7B

| | A10 | A12 | A14 | A16 |
|---|---|---|---|---|
| 1st surface | 5.194977E−03 | −7.991241E−03 | −2.075138E−06 | −3.315171E−06 |
| 2nd surface | 1.343410E−02 | −2.288511E−02 | −9.912285E−06 | 1.577398E−06 |
| 3rd surface* | 8.832460E−03 | −1.613245E−02 | −1.671317E−03 | −4.618044E−04 |
| 4th surface | 1.940845E−02 | −7.422658E−03 | 9.903552E−04 | −3.416001E−03 |
| 5th surface | −4.323330E−03 | 5.810905E−04 | 2.338942E−04 | 5.303975E−05 |
| 6th surface | 3.287594E−03 | −2.789318E−04 | 3.787229E−06 | −1.155397E−05 |
| 7th surface | −1.214690E−04 | 1.082128E−05 | 5.258044E−08 | −2.268438E−08 |
| 8th surface | 2.201494E−04 | −9.713200E−06 | 1.174817E−07 | −3.952187E−09 |

In Tables 6, 7A and 7B, the surface marked with an asterisk (the third surface: the surface of the second lens 9 facing the object side) is a diffractive optical element surface, and a specific numerical example of the diffractive optical element surface is provided in Table 8 below.

TABLE 8

| | |
|---|---|
| Design wavelength | 546.07 nm |
| Diffraction order | 1 |
| C2 | −6.127640E−03 |
| C4 | 1.050263E−04 |

With regard to the image pickup lens 14 of the comparative example, Table 9 below provides the F number Fno, the focal distance f (mm) of the overall optical system, the overall optical length TL (mm) measured in terms of air, the maximum image height Y′, the value of the conditional expression (1), the effective diameter (radius) (mm) of the diffractive optical element surface, and the number of diffraction zones within the effective diameter.

TABLE 9

| | |
|---|---|
| Fno | 2.88 |
| f (mm) | 4.2 |
| TL (in terms of air) (mm) | 5.31 |
| Y′ | 2.86 |
| Conditional expression (1) f_{DOE}/f | 19.4 |
| Effective diameter of diffractive optical element | 1.00 |
| (radius) (mm) | |
| Number of diffraction zones within effective | 11 |
| diameter | |

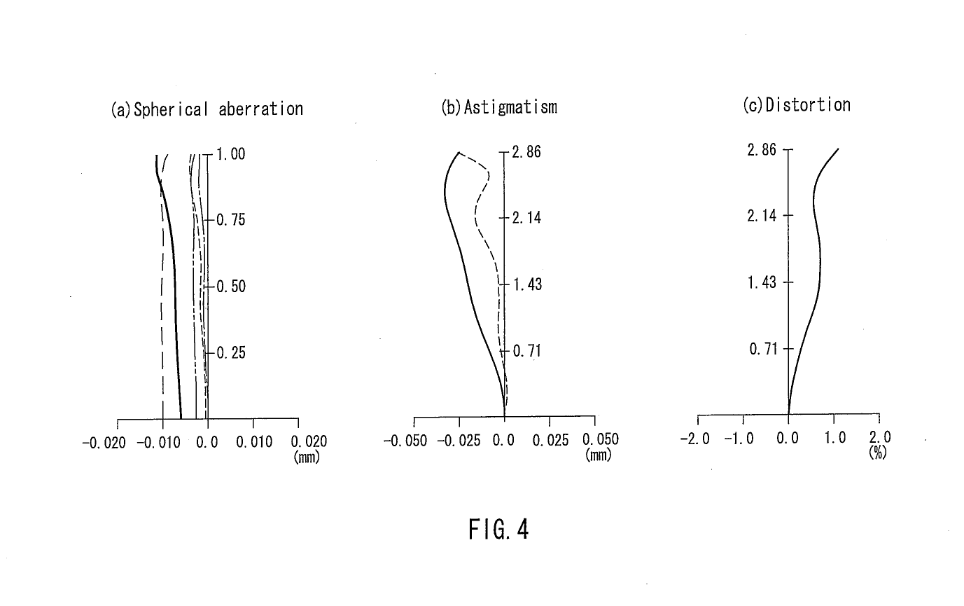

FIG. 4 shows graphs of aberrations associated with the image pickup lens of the comparative example. FIG. 4(a) is a graph of spherical aberration. In FIG. 4(a), a solid line indicates values at the g line, a short dashed line indicates values at the F line, a chain line indicates values at the e line, a double chain line indicates values at the d line, and a long dashed line indicates values at the C line. FIG. 4(b) is a graph of astigmatism. In FIG. 4(b), a solid line indicates a sagittal field curvature and a dashed line indicates a meridional field curvature. FIG. 4(c) is a graph of distortion. Note that longitudinal chromatic aberration can be read from the graph of spherical aberration in FIG. 4(a).

As can be seen from the graphs of aberration in FIG. 4, the image pickup lens 14 of the comparative example allows favorable correction of a variety of aberrations and is compatible with small high-pixel image pickup elements (e.g., CCD and CMOS image sensors having a pixel pitch of 2 μm or less and a pixel count of 5 mega pixels, 8 mega pixels or 13 mega pixels) incorporated in small portable devices such as mobile phones.

However, in view of the results provided in Tables 1 and 9, it is clear that the image pickup lens 14 of the comparative example is unable to suppress flare caused by unnecessary diffraction order light.

Thus, for an image pickup device using the image pickup lens of the comparative example, even if the image pickup device uses a high definition image pickup element having a high pixel count, it may be considered that image degradation occurred. Thus, the image quality cannot be improved.

### Embodiment 2

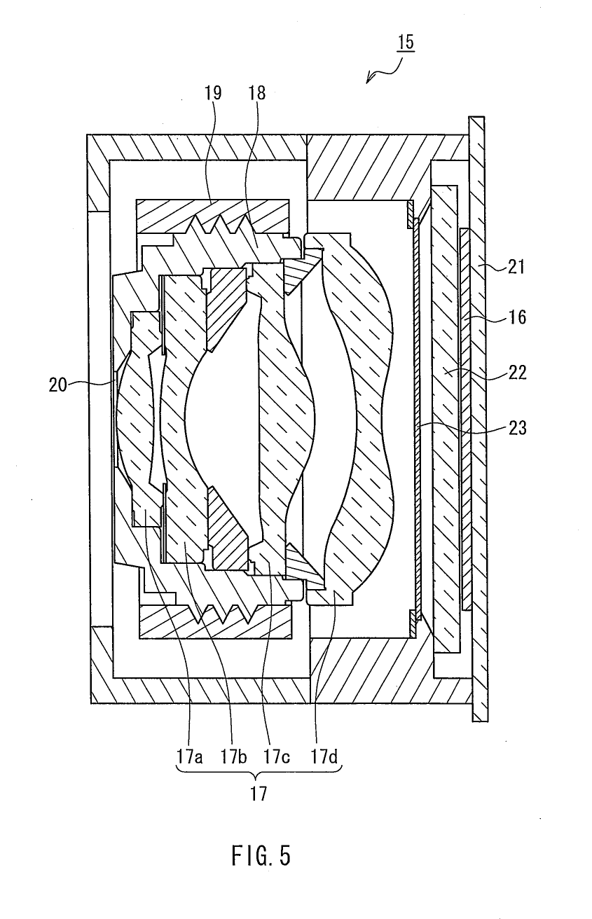

Next, an image pickup device using the image pickup lens of the present invention will be described with reference to FIG. 5. FIG. 5 is a cross-sectional view showing a configuration of an image pickup device according to Embodiment 2 of the present invention.

As shown in FIG. 5, the image pickup device 15 according to the present embodiment includes an image pickup element 16 and an image pickup lens 17. Here, the image pickup element 16 converts an optical signal corresponding to an object into an image signal and outputs the image signal. Further, the image pickup lens 17 includes, in order from the object side (the left side of FIG. 5) to the image surface side (the right side of FIG. 5): a first lens 17a having positive power; a second lens 17b that is a meniscus lens having negative power and whose lens surface facing the image surface side is concave; a third lens 17c that is a meniscus lens having positive power and whose lens surface facing the image surface side is convex; and a fourth lens 17d that has negative power, whose lens surfaces are both aspherical and whose lens surface facing the image surface side is concave near the optical axis. And a diffractive optical element is formed on at least one lens surface of the first lens 17a to the forth lens 17d constituting the image pickup lens 17 (for a specific example of the image pickup lens 17, see Embodiment 1 and Example thereof).

The image pickup lens 17 is housed in a lens-barrel 18, and the lens-barrel 18 is held by a cylindrical holder 19 through engagement between male screws and female screws. The lens-barrel 18 has an opening 20 on the object side. The opening 20 serves as an aperture stop for the image pickup lens 17.

In FIG. 5, 21 denotes a substrate on which the image pickup element 16 is provided, 22 denotes a faceplate (glass cover) of the image pickup element 16, and 23 denotes an infrared (IR) cut filter.

According to the configuration of the image pickup device 15 of the present embodiment, the image pickup lens of the present invention (e.g., the image pickup lens 7 according to Embodiment 1) is used as the image pickup lens 17. Thus, it is possible adequately to suppress flare caused by unnecessary diffraction order light. Further, since design diffraction order light can be used to correct chromatic aberration favorably, a small high-pixel image pickup element can be used. As a result, it is possible to provide a high definition and high image quality image pickup device.

Although the image pickup lens 17 composed of four lenses is used in the present embodiment, the number of lenses included in the image pickup lens is not limited as long as the image pickup lens includes at least one lens and a diffractive optical element is formed on at least one lens surface of the at least one lens.

### Embodiment 3

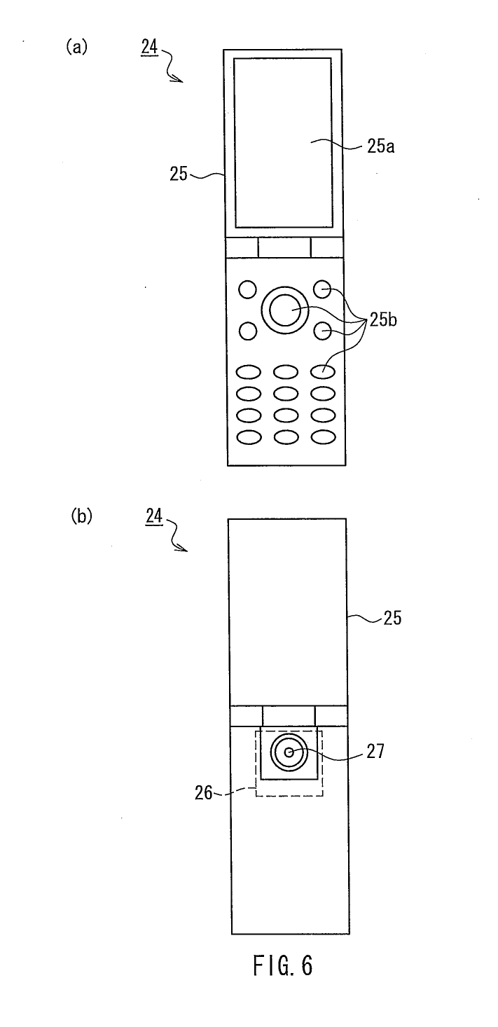

Next, a portable device equipped with the image pickup device of the present invention will be described with reference to FIG. 6. FIG. 6(a) is a plan view and FIG. 6(b) is a rear view showing a configuration of a mobile phone as the portable device according to Embodiment 3 of the present invention.

As shown in FIG. 6, the portable device 24 according to the present embodiment is a mobile phone equipped with a camera, and includes a case 25, a display 25a and operating portions 25b provided on the case 25, and an image pickup device 26 incorporated in the case 25.

The image pickup device 26 includes an image pickup element and an image pickup lens, and the image pickup element converts an optical signal corresponding to an object into an image signal and outputs the image signal (for a specific example of the image pickup device 26, see Embodiment 2). Here, the image pickup lens includes, in order from the object side (the backside of the portable device 24) to the image surface side (the front side of the portable device 24): a first lens 27 having positive power (see FIG. 6(b)); a second lens that is a meniscus lens having negative power and whose lens surface facing the image surface side is concave; a third lens that is a meniscus lens having positive power and whose lens surface facing the image surface side is convex; and a fourth lens that has negative power, whose lens surfaces are both aspherical and whose lens surface facing the image surface side is concave near the optical axis. And a diffractive optical element is formed on at least one lens surface of the first lens 27 and the second to fourth lenses constituting the image pickup lens (for a specific example of the image pickup lens, see Embodiment 1 and Example thereof).

According to the configuration of the portable device 24 of the present embodiment, since the portable device 24 is equipped with the image pickup device of the present invention (e.g., the image pickup device 15 according to Embodiment 2) as the image pickup device 47, the definition and image quality of the portable device can be enhanced. Thus, it is possible to provide a high-performance portable device such as a mobile phone.

Although the image pickup lens composed of four lenses is used in the present embodiment, the number of lenses included in the image pickup lens is not limited as long as the image pickup lens includes at least one lens and a diffractive optical element is formed on at least one lens surface of the at least one lens.

### INDUSTRIAL APPLICABILITY

Since the image pickup lens of the present invention can adequately suppress flare caused by unnecessary diffraction order light, it is particularly useful in the field of small portable devices, such as mobile phones, equipped with an image pickup device, which are desired to be high definition and have high image quality.

### DESCRIPTION OF REFERENCE NUMERALS

1, 17a, 27 first lens

2, 17b second lens

3, 17c third lens

4, 17d fourth lens

5 aperture stop

6 parallel plate

7, 17 image pickup lens

15, 26 image pickup device

16 image pickup element

18 lens-barrel

19 holder

20 opening

21 substrate

22 faceplate (cover glass) of image pickup element

23 infrared (IR) cut filter

24 portable device

25 case

25a display

25b operating portions

S image pickup surface

1. An image pickup device comprising:
an image pickup element for converting an optical signal corresponding to an object into an image signal and outputting the image signal, the image pickup element having a pixel pitch of 2 μm or less and a pixel count of 5 mega pixels, 8 mega pixels or 13 mega pixels; and
an image pickup lens for forming an image of the object onto an image pickup surface of the image pickup element,
wherein the image pickup lens includes at least one lens,
a diffractive optical element is formed on at least one lens surface of the at least one lens,
the lens surface provided with the diffractive optical element has 3 or fewer diffraction zones within its effective diameter, and
the image pickup lens satisfies the following conditional expression (1):
fb_{DOE}/f>30 (1)
where f is a focal distance of an overall optical system, and f_{DOE} is a focal distance of the diffractive optical element alone.

2. The image pickup device according to claim 1, wherein the diffractive optical element is of a single layer type.

3. The image pickup device according to claim 1,
wherein the image pickup lens further includes an aperture stop,
light is incident through the aperture stop, and the diffractive optical element is formed on at least one lens surface of the at least one lens that is disposed closest to the aperture stop.

4. The image pickup device according to claim 1,
wherein the image pickup lens includes at least two lens and an aperture stop,
of the at least two lenses, a first lens is disposed closest to an object side and a second lens is disposed adjacent to the first lens, the aperture stop is provided on the object side of the first lens, and the diffractive optical element is formed on a lens surface of the second lens facing the object side.

5. The image pickup device according to claim 1, wherein the image pickup lens has an F number of 2.4 to 3.2.

6. (canceled)

7. A portable device equipped with the image pickup device according to claim 1.
